(19) United States
(12) Patent Application Publication
(10) Pub. No.: US 2020/0394162 A1
(43) Pub. Date: Dec. 17, 2020

(54) OPERATION MANAGEMENT METHOD FOR DISTRIBUTED LEDGER SYSTEM, OPERATION MANAGEMENT SYSTEM FOR DISTRIBUTED LEDGER SYSTEM, AND OPERATION MANAGEMENT PROGRAM FOR DISTRIBUTED LEDGER SYSTEM

(71) Applicant: HITACHI, LTD., Tokyo (JP)

(72) Inventor: Daisuke IIZUKA, Tokyo (JP)

(73) Assignee: HITACHI, LTD., Tokyo (JP)

(21) Appl. No.: 16/818,116

(22) Filed: Mar. 13, 2020

(30) Foreign Application Priority Data
Jun. 17, 2019 (JP) 2019-112150

(51) Int. Cl. G06F 16/182; G06F 16/9035; G06F 9/30; H04L 9/06

(52) U.S. Cl. CPC G06F 16/1844; H04L 9/0643; G06F 9/30029; G06F 16/9035

(57) ABSTRACT

An operation management method for a distributed ledger system, wherein, in copying data to a distributed ledger included in a first distributed ledger node from a distributed ledger included in a second distributed ledger node group in the distributed ledger system when a content of the distributed ledger held by the first distributed ledger node is less than a content of the distributed ledger held by the second distributed ledger node group, the first distributed ledger node determines a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

### CROSS-REFERENCE TO RELATED APPLICATION

This application claims priority pursuant to 35 U.S.C. § 119 from Japanese Patent Application No. 2019-112150, filed on Jun. 17, 2019, the entire disclosure of which is incorporated herein by reference.

### BACKGROUND

### Technical Field

The present invention relates to an operation management method for a distributed ledger system, an operation management system for the distributed ledger system, and an operation management program for the distributed ledger system.

### Related Art

Conventionally, many transactions have been conducted through trusted central authorities such as financial institutions and governments. However, in recent years, Peer-to-Peer (P2P) transaction between users, which is different from the conventional transactions, has been proposed. Such a proposed transaction is implemented by a distributed ledger technology by way of example.

An example of such a distributed ledger technology is a technology for performing payment transactions using a virtual currency called Bitcoin without requiring a central authority such as a bank (see “A Peer-to-Peer Electronic Cash System”, [retrieved on 2017.03.31], Retrieved from <URL: https://bitcoin.org/bitcoin.pdf>). In Bitcoin, a node called a miner determines the validity of transaction data (hereinafter, also referred to as a transaction) on a P2P network, and then performs a determination process by a specific work (calculating a hash) called a proof-of-work.

The transactions that have been determined as described above are grouped into a block, and the block is recorded in a distributed ledger called a blockchain (hereinafter, also referred to as a BC) at each node.

On the other hand, based on a BC implemented by the Bitcoin technology described above, various derivative technologies in terms of the BC and the distributed ledger have been further proposed and progressed.

The main features of the current BC are as follows: (1) In a transaction between participants on a business network, the transaction is determined through consensus building and approval by (any or a specific) participant, not by the central authority, (2) Blocks, into which a plurality of transactions are grouped, are recorded in distributed ledgers in a daisy chain, and hash calculation is performed on consecutive blocks to make them virtually impossible to falsify, and (3) Sharing the same ledger data among all participants enables all the participants to confirm the transactions.

By using an infrastructure for providing such a distributed ledger (hereinafter, referred to as a distributed ledger infrastructure), information sharing and transactions can be performed among a plurality of entities without management by a central authority (e.g., multiple companies involved in consortiums and supply chains in a specific industry). Here, a network composed of participants (and their nodes) participating in a distributed ledger is referred to as a business network.

Due to the above features, the distributed ledger technology such as the BC described above is being considered for use in applications in a wide range of fields such as the financial field and the Internet of Things (IoT), as a mechanism for managing/sharing reliable data and executing/managing transactions based on contracts.

For example, in order to be applicable not only to simple virtual currency transactions such as Bitcoin, but also to complex transaction conditions and various applications, a distributed ledger allows for management of not only (transaction) data but also logic therein. This logic is called a smart contract (hereinafter, also referred to as an SC).

On the other hand, in a distributed ledger platform having an SC execution function (see “Ethereum White Paper”, [retrieved on 2017.03.31], Retrieved from <URL: https://gitub.com/ethereum/wiki/wiki/[English]-White-Paper>, and “Hyperledger Fabric”, [retrieved on 2019.03.31], Retrieved from <URL: http://hyperledger-fabric. readthedocs.io/en/latest/>), a transaction (hereinafter, also referred to as a TX) is received while a consensus is built between nodes at a predetermined agreement level, and the TX is executed in each node so that information (ledger) is shared among a plurality of nodes. In addition, the platform has a smart contract (SC) execution function for executing a predetermined logic for the TX.

When another organization adds a new distributed ledger node, it is necessary to make a copy of the distributed ledger from an existing distributed ledger node.

In a blockchain system in which a network is composed of a plurality of servers and each server holds logically the same data, a new server is required to make a copy of all the data on the network in advance to come into a state where the new server participates in the blockchain network and is ready to process transactions.

However, for a large amount of data on the network, it takes a long time to complete the copying of all the data.

As a method for reducing the time for copying data in a distributed computing system, for example, a technique disclosed in Japanese Translation of PCT Application No. 2013-532314 is known. Japanese Translation of PCT Application No. 2013-532314 discloses a technique in which a new server does not acquire all data (all files) in advance, but a storage system acquires relevant data from an existing server on demand at an access timing.

The technique disclosed in Japanese Translation of PCT Application No. 2013-532314 described above acquires one piece of data from one copy source. Accordingly, that technique in implementation and operation is reliable only when the copy source server returns correct data.

The reason is that, in an environment using distributed ledger nodes, the distributed ledger nodes are built across multiple organizations, and a distributed ledger node serving as the copy source may be operated by an organization that is not always reliable. In that case, there is a possibility that erroneous data is sent maliciously at the time of copying.

As a countermeasure for such a case where the copy source organization is not always reliable, a copy of all data in all distributed ledger nodes can be temporarily made to compare whether two sets of the temporary copy data are identical to each other.

However, for a huge amount of data, there are other problems such as a long copy time, a huge resource where the temporary copy is stored, and an increase in the load of other distributed ledger nodes and networks which adversely affects the transaction process.

Therefore, an object of the present invention is to provide a technology capable of efficient copying of a blockchain from an existing distributed ledger node while preventing tampering.

### SUMMARY

An operation management method for a distributed ledger system of the present invention which solves the above problems comprises, in copying data to a distributed ledger included in a first distributed ledger node from a distributed ledger included in a second distributed ledger node group in the distributed ledger system when a content of the distributed ledger held by the first distributed ledger node is less than a content of the distributed ledger held by the second distributed ledger node group, by the first distributed ledger node, determining a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

An operation management system for a distributed ledger system of the present invention comprises a first distributed ledger node in the distributed ledger system, configured to copy data to a distributed ledger included in the first distributed ledger node from a distributed ledger included in a second distributed ledger node group when a content of the distributed ledger held by the first distributed ledger node is less than a content of the distributed ledger held by the second distributed ledger node group, and determine a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

An operation management program for a distributed ledger system of the present invention causes a first distributed ledger node in the distributed ledger system to execute a process, wherein the first distributed ledger node is configured to copy data to a distributed ledger included in the first distributed ledger node from a distributed ledger included in a second distributed ledger node group when a content of the distributed ledger held by the first distributed ledger node is less than a content of the distributed ledger held by the second distributed ledger node group, and the process is configured to determine a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

According to the present invention, it is possible to make a copy of a blockchain from an existing distributed ledger node efficiently while preventing tampering.

### BRIEF DESCRIPTION OF THE DRAWINGS

FIG. 1 is a diagram illustrating a basic concept in an operation management method of a distributed ledger system according to an embodiment;

FIG. 2 is a diagram schematically illustrating an operation management system according to the embodiment;

FIG. 3 is a block diagram illustrating a physical configuration of a distributed ledger node in the embodiment;

FIG. 4 illustrates an example of a data structure of a blockchain in a distributed ledger according to the embodiment;

FIG. 5 illustrates an example of a data structure of state information in a distributed ledger according to the embodiment;

FIG. 6 illustrates a data structure of participating member management information in the embodiment;

FIG. 7 is a flowchart illustrating an example of a process of registering a new member of a business network according to the embodiment;

FIG. 8 is a flowchart illustrating an example of a transaction process according to the embodiment;

FIG. 9 is a flowchart illustrating an example of a process of copying a distributed ledger when a new distribution process node is added in the embodiment;

FIG. 10 is a flowchart illustrating an example of a process of verifying whether the contents of a blockchain copied from a plurality of distributed ledgers are correct according to the embodiment;

FIG. 11 illustrates an example of a block division method when a block is copied from a distributed processing node in the embodiment; and

FIG. 12 illustrates the example of the block division method when copying a block from the distributed processing node according to the embodiment.

### DETAILED DESCRIPTION OF EMBODIMENTS

### First Example

### <Basic Concept of Operation Management Method>

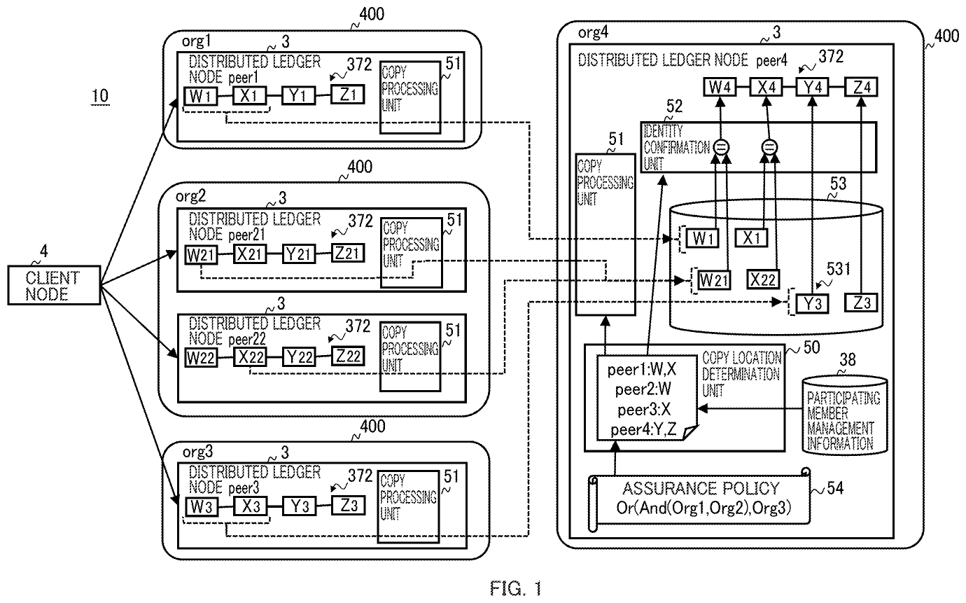

FIG. 1 illustrates a basic concept in an operation management method of a distributed ledger system 10 according to an embodiment. In the present embodiment, a case will be described in which peer 4 is added as a new distributed ledger node 3 (i.e., a first distributed ledger node).

In this case, a copy location determination unit 50 in the new distributed ledger node 3 determines, based on an assurance policy 54 and participating member management information 38, which block group is to be acquired in a blockchain 372 from which distributed ledger node 3 (i.e., a second distributed ledger node group) included in the distributed ledger system 10. The distributed ledger system 10 may be referred to as an operation management system.

A copy processing unit 51 of the new distributed ledger node 3 described above acquires a block group from the respective distributed ledger nodes 3 (the second distributed ledger node group) in accordance with a copy policy determined by the copy location determination unit 50, and stores the block group in a copy buffer 53.

An identity confirmation unit 52 in the new distributed ledger node 3 described above compares the contents of the blocks at the same location acquired from the plurality of distributed ledger nodes 3 (the second distributed ledger node group) with each other, and verifies the result. When the result of the verification indicates that the contents of the blocks are the same, the identity confirmation unit 52 copies the block 531 from the copy buffer 53 and builds a blockchain 372.

### <Configuration Example of Operation Management System>

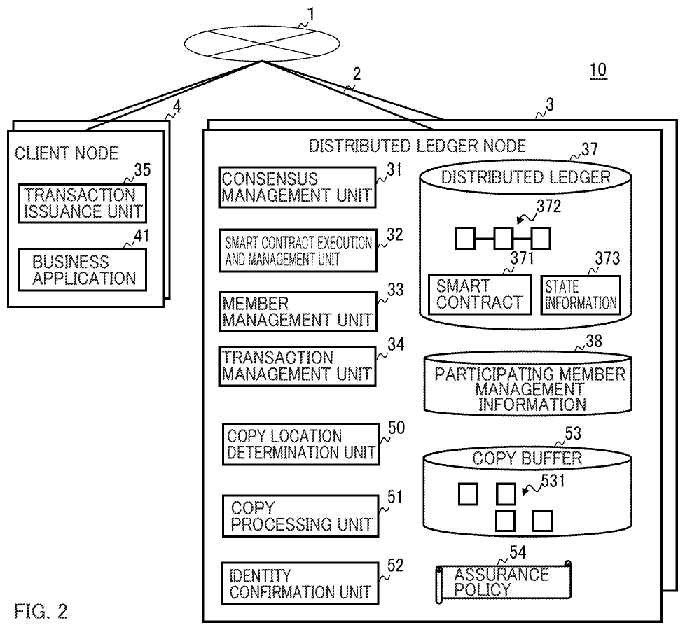

Next, a configuration example of a computer system that implements the above-described basic concept, that is, the operation management system 10 will be described. FIG. 2 is a diagram schematically illustrating the operation management system 10 according to the first example.

The operation management system 10 illustrated by way of example includes one or more distributed ledger nodes 3 and one or more client nodes 4 (also referred to as a distributed ledger system). These devices are connected to a network 1 through a physical communication line 2.

In the above-described configuration, the distributed ledger node 3 includes a consensus management unit 31, a smart contract execution and management unit 32 (hereinafter, also referred to as an SC execution and management unit 32), a member management unit 33, a transaction management unit 34, the distributed ledger 37, the participating member management information 38, the copy location determination unit 50, the copy processing unit 51, the identity confirmation unit 52, the copy buffer 53, and the assurance policy 54.

The distributed ledger node 3 having such a configuration receives a TX by using the function of the transaction management unit 34 and builds a consensus with another node to receive the TX by using the function of the consensus management unit 31.

In response to the above consensus building, the distributed ledger node 3 also deploys an SC and executes the deployed SC through the function of the SC execution and management unit 32, and records the history of the TX and the execution result in the distributed ledger 37.

Note that communication between the distributed ledger nodes 3 is performed by using the function of the consensus management unit 31. The transaction management unit 34 of the distributed ledger node 3 provides a function and interface for receiving a TX in response to a request from each node such as the client node 4 and acquiring/browsing history information of the TX.

The member management unit 33 of the distributed ledger node 3 provides a function for newly issuing a member who participates in the business network and an authentication function. In such member management, it is assumed that a pair of a secret key and a public key is used to authenticate a participating member, sign a TX, control SC execution authority, and the like. Note that key information related to member management is stored and managed in the participating member management information 38.

When receiving a TX, the transaction management unit 34 checks, as appropriate, whether or not the TX issuer is an authorized participant who has authority through the function of the member management unit 33. Such a configuration may be implemented by an appropriate known technique, detailed description of which is omitted.

In the distributed ledger 37, a smart contract (SC) 371, a blockchain (BC) 372, and state information 373 are stored and managed. In the present embodiment, its data structure is assumed in which a BC serves as the history of a TX and state information based on the execution result of the TX is held on a table.

On the other hand, the client node 4 includes a transaction issuance unit 35 and a business application 41.

The user or provider of an SC issues various TXs via the transaction issuance unit 35 of the client node 4 and transmits them to the respective distributed ledger nodes 3. Note that the TX is assigned issuer information, and as such information, authentication information (secret key) issued by the participating member management information 38 is used.

The business application 41 is an application that executes and manages a business process by issuing a TX related to the smart contract 371 via the transaction issuance unit 35.

In the present example, for example, it is assumed that there are a plurality of distributed ledger nodes 3 managed by different entities. Examples of the entities include a business entity, an organization, and a vendor. Similarly, it is assumed that there are a plurality of client nodes 4 and a plurality of SC users use different client nodes 4.

Note that the client node 4 can be shared among a plurality of SC users by switching the authentication information assigned to a TX for each user.

### <Physical Configuration of Distributed Ledger Node>

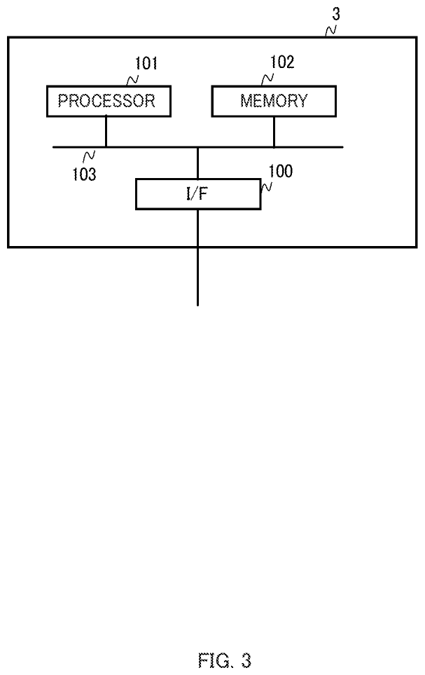

Subsequently, a physical configuration of the distributed ledger node 3 in the first example will be described. FIG. 3 is a block diagram illustrating an example of a physical configuration of the distributed ledger node 3 in the first example.

The distributed ledger node 3 in the present example is a computer including an interface (I/F) 100, a processor 101 serving as an arithmetic device, and a memory 102 serving as a storage device. Note that the I/F 100, the processor 101, and the memory 102 are connected by a data bus 103.

The distributed ledger node 3 having such a configuration communicates with the network 1 via the I/F 100. The processor 101 is an arithmetic device such as a CPU. The memory 102 is a storage device for holding programs and data. The processor 101 reads a program 110 (a program corresponding to the copy location determination unit 50, the copy processing unit 51, and the identity confirmation unit 52) from the memory 102 via the data bus 103, and implements necessary functions by executing the program.

### <Configuration of Distributed Ledger>

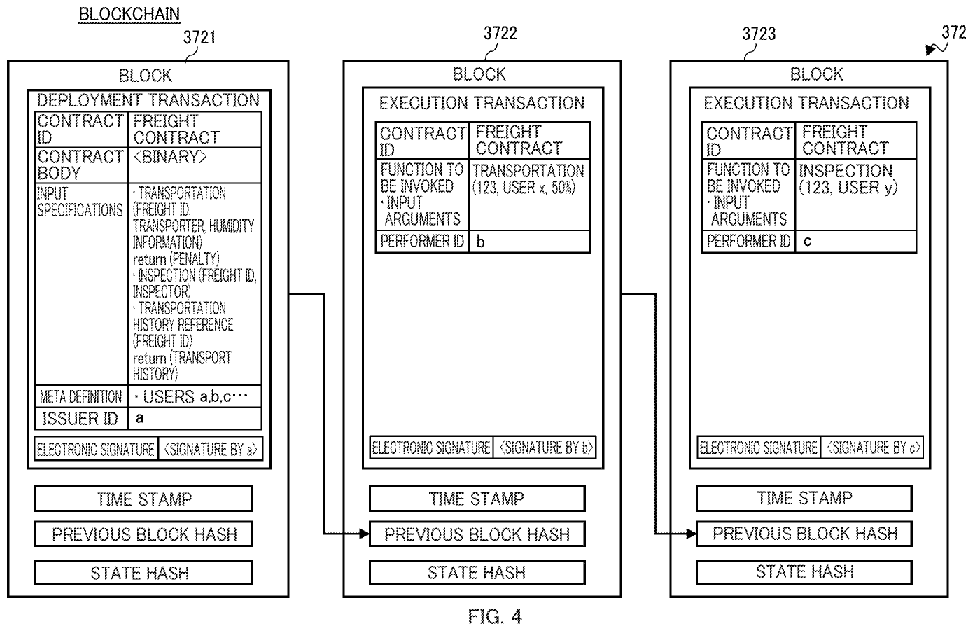

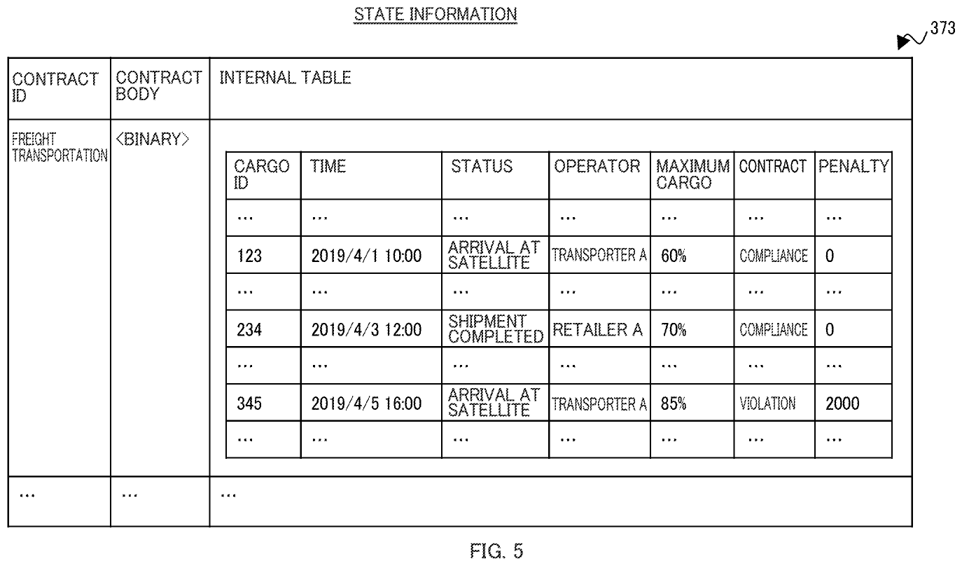

Next, a configuration example of the distributed ledger 37 will be described. FIGS. 4 and 5 illustrate an example of a data structure stored in the distributed ledger 37. Out of these figures, FIG. 4 illustrates an example of the BC 372, which is one of the data structures managed in the distributed ledger 37.

In distributed ledger management using a BC, a plurality of TXs are grouped into blocks, each block has the hash of the previous block, and data is managed in a daisy chain. In such a configuration, if the value of the previous block changes even by one bit, the hashes of all subsequent blocks change. This makes it hard to tamper the TX. Note that, in the present example, for simplicity of description, one block is set for one TX, but the present invention is also applicable to a case where a plurality of TXs are collectively stored in one block.

A block 3721, a block 3722, and a block 3723 in FIG. 4 are a series of blocks, that is, build a BC.

Each block includes TX information on either deployment or execution of an SC. Each block also includes timestamp information related to the generation of that block. Further, each block includes the hash of the previous block and a hash generated from state information described later.

With the data structure as described above, the deployment or execution TXs of the SC are managed as a chain of data in the BC.

Among the blocks composing the BC, the block 3721 is an example of a block storing the deployment TX of the SC 371. In this example, an example of a business contract related to freight transportation is illustrated.

The deployment TX of the present example includes a contract ID for uniquely identifying a contract and a contract body (e.g., an executable binary). The deployment TX also includes contract input specifications for the user to know function names of the contract and their arguments.

The deployment TX also includes a contract meta definition which is a parameter (e.g., a contract user and various definition information) determined according to an input argument specified at the time of deployment. The deployment TX also includes ID information (issuer ID) for identifying an issuer of the deployment TX, that is, a provider.

The deployment TX also includes an electronic signature used to verify that the issuer and data have not been tampered with. This electronic signature is generated using the secret key of each network participating member (i.e., an SC provider or user) issued by the member management unit 33, and can be verified with the public key that forms a pair with the secret key.

The blocks 3722 and 3723 are each an example of a block storing the execution TX of the SC 371. The execution TX of the present example includes a contract ID of a contract to be invoked, a function name of the contract to be invoked, and information on input arguments.

The execution TX also includes ID information (performer ID) for identifying an issuer of the actual execution TX, that is, a user. The execution TX also includes a user signature used to verify that the issuer and data have not been tampered with. Note that information on network participants involved in consensus building as well as the issuer may be managed and held.

FIG. 5 illustrates the state information 373 managed in the distributed ledger 37 in the present example. In distributed ledger management using a BC, usually, in order to acquire the (latest) state (e.g., account balance in the case of virtual currency), it is necessary to trace the BC. Since this has poor processing efficiency, there is a method of caching the latest state information separately from the BC (“Hyperledger Fabric” referred to above). Therefore, in the present example, it is assumed that the latest state information is held.

In the present example, a state data area is prepared for each contract. The state information holds a contract ID and a contract body.

Thus, the SC execution and management unit 32 of the distributed ledger node 3 can acquire and execute the contract body using the contract ID as a key. The state information also includes an internal table for holding an execution result of an SC. The content of the internal table is updated each time a TX is executed.

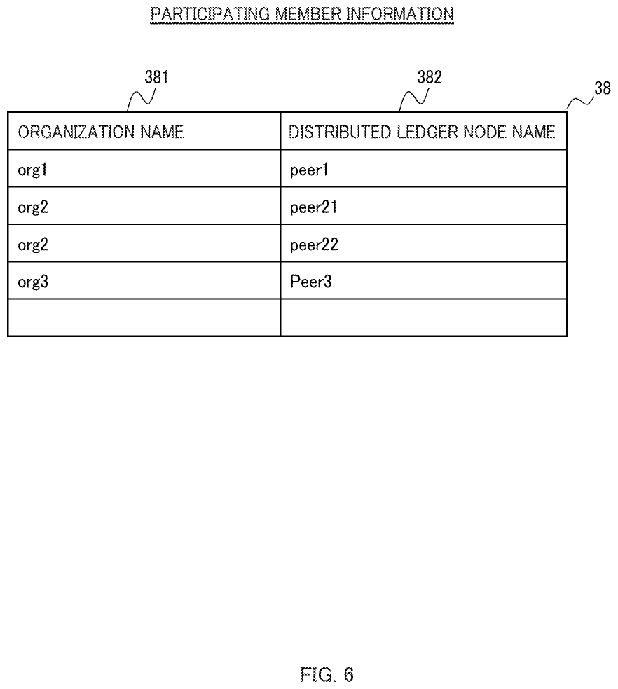

FIG. 6 is an example of the participating member management information 38 in the present example. The participating member management information 38 is in a table format and includes one or more rows. Every row has two columns. Here, the two columns are an organization name 381 and a distributed ledger node name 382.

Each row of the participating member management information 38 may has other columns (not illustrated) or may not have one or some of them. The information stored in the participating member management information 38 may be manually created by, for example, a system administrator, or may be created using some tool or utility.

The participation member management information 38 stores information including the name 381 of an organization that operates the distributed ledger node 3 and the name 302 of the distributed ledger node owned by the organization.

### <Flow Example: New Member Registration>

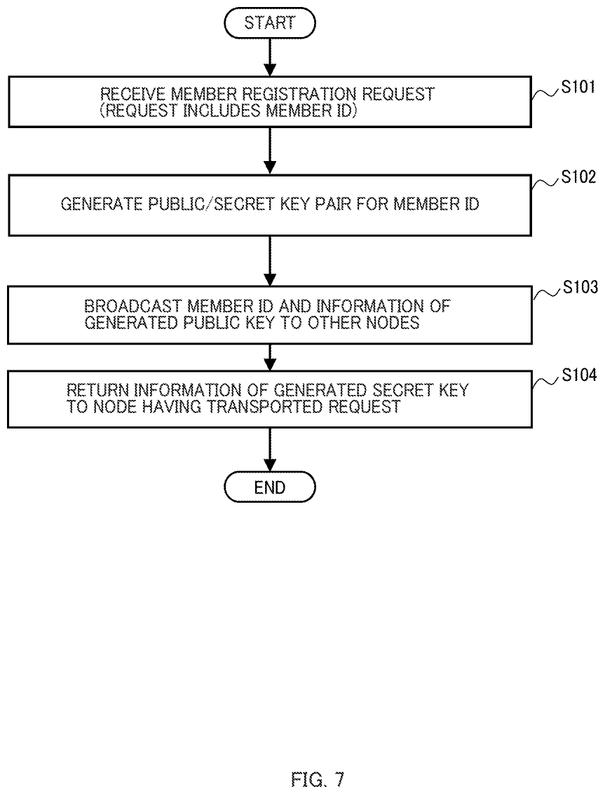

FIG. 7 is a flowchart illustrating an example of a new registration process of a member participating in the business network. In this case, the member management unit 33 of the distributed ledger node 3 receives a member registration request from another node such as the client node 4 (S101). The member registration request includes a member ID for uniquely identifying the member to be requested.

Subsequently, the member management unit 33 generates a set of a secret key and a public key by an appropriate algorithm, and associates the set with the member ID received in step S101 described above (S102).

Next, the member management unit 33 broadcasts the member ID to be newly registered acquired in step S101 described above and the public key generated in step S102 described above to another node (S103).

The information on the member ID and the public key broadcast here is stored as the participating member management information 38 in each node.

Further, the member management unit 33 returns the secret key generated in step S102 to the node that has transmitted the member registration request (the node that has triggered S101) (S104). On the other hand, the node that has received the secret key stores it in the participating member management information 38 as its own secret key.

In the present example, it is assumed that the pair of the secret key and the public key generated as described above is used to authenticate a network participating member, sign a TX, control SC execution authority, and the like.

Specifically, for example, the client node 4 side issues a TX with an electronic signature using the issued secret key, and a verification node side verifies the electronic signature using the public key, thereby realizing identity verification.

Note that a known or well-known technique may be applied to a method for generating a pair of the public key and the secret key, a method for verifying the signature, and a method for associating the keys with an ID. Therefore, their details are not described in the first example. In the present example, the function of the member management unit 33 is illustrated as a function in the distributed ledger node 3. However, a node specialized for member management may be set up outside so that the node can provide the same function as the member management unit 33.

### <Flow Example: TX Execution Process>

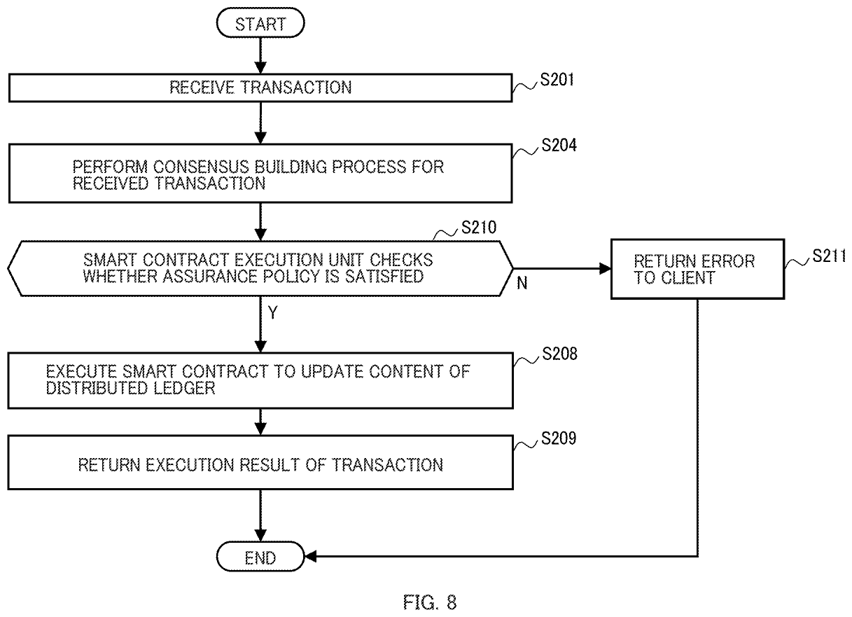

Subsequently, a TX execution process will be described. FIG. 8 is a flowchart illustrating an example of the TX execution process. In this case, the transaction management unit 34 of the distributed ledger node 3 receives a TX from a TX issuer such as the client node 4 (S201), and passes it to the consensus management unit 31 to perform an execution process.

The consensus management unit 31 performs a consensus building process with another distributed ledger nodes 3 as to whether the received TX is to be executed or to be added to the end of the BC as a block (S204).

As a specific procedure of the consensus building process, a known or well-known technique may be used. Here, consensus building is to be made in accordance with the assurance policy 54.

Briefly describing the consensus building using the assurance policy 54, the consensus management unit 31 refers to the participating member management information 38 for each organization specified in the assurance policy 54, and selects one distributed ledger node 3.

Further, in the selected distributed ledger node 3, the signature for the TX is verified to check whether the TX has not been tampered with and the validity of the content of the TX, and the result of the check is transmitted to the consensus management unit 31.

The consensus management unit 31 performs a logical operation in accordance with the assurance policy 54 using the result of whether each organization has agreed or rejected, and determines whether consensus building has been completed or rejected (S210). A method of consensus building using the assurance policy 54 will be described later.

As a result of the above determination, if the consensus building is rejected (S210: N), the consensus management unit 31 returns an error to the client (S211) and ends the processing.

On the other hand, if the consensus building is completed (S210: Y), the consensus management unit 31 executes the SC through the SC execution and management unit 32 to update the contents of the distributed ledger 37 (S208).

Specifically, the consensus management unit 31 passes the function to be invoked and the input arguments specified in the execution TX to the SC having the contract ID specified in the execution TX (assuming that the SC has been registered) to be executed. Then, the content of the distributed ledger 37 are updated based on the result. In addition, the consensus management unit 31 updates the state information 502 related to the contract based on the execution result, and adds the execution TX as the last block of the BC.

Finally, the consensus management unit 31 returns the execution result (e.g., a return value of the function) of the execution TX to the TX issuance source (S209), and ends the processing.

Here, a consensus building method using the assurance policy 54 will be described. The assurance policy 54 is equivalent to an endorsement policy used in “Hyperledger Fabric” referred to above. The assurance policy 54 includes a conditional statement and a conditional element. The assurance policy 54 is evaluated as true or false in consensus building.

The conditional statement in the assurance policy 54 is one of Or, And, and OutOf. However, other conditional statements may be used. Note that for the conditional statement being OutOf, the conditional statement has one additional argument k. The additional argument k is determined as a part of the conditional statement, not a conditional element.

The conditional element in the assurance policy 54 includes an organization name 400 or a conditional statement. In consensus building, the conditional element is evaluated as true or false. For the conditional element being the organization name 400, the conditional element is evaluated as true if the corresponding organization agrees on the consensus building. If the organization rejects on the consensus building, the conditional element is evaluated as false. If neither has been agreed nor rejected, the conditional element is in an unevaluated state until the agreement or rejection is obtained.

For the conditional element being a conditional statement, the value (true or false) of the conditional statement is evaluated as it is. For the conditional statement being Or, the conditional statement is evaluated as true if at least one conditional element is true. If there is an unevaluated conditional element, the conditional statement is in an unevaluated state. Otherwise, the conditional statement is evaluated as false.

For the conditional statement being And, the conditional statement is evaluated as true if all the conditional elements are evaluated as true. If there is an unevaluated conditional element, the conditional statement is in an unevaluated state. Otherwise, the conditional statement is evaluated as false.

For the conditional statement being OutOf, the conditional statement is evaluated as true if at least k conditional elements are evaluated as true. If there is an unevaluated conditional element, the conditional statement is in an unevaluated state. Otherwise, the conditional statement is evaluated as false.

An example of such an assurance policy 54 and an example of its evaluation result will be described below. Here, it is assumed that Org1, Org2, and Org3 are the organizations 400 illustrated in FIG. 1.
Or (Org1, Org2, Org3): Evaluated as true when the distributed ledger node 3 of at least one organization of Org1, Org2, and Org3 agrees.
And (Org1, Org2, Org3): Evaluated as true when the distributed ledger nodes 3 of all the organizations of Org1, Org2, and Org3 agree.
OutOf (2, Org1, Org2, Org3): Evaluated as true when the distributed ledger nodes 3 of at least two organizations of Org1, Org2, and Org3 agree.
Or (And (Org1, Org2), Org3): Evaluated as true when both Org1 and Org2 or Org3 or all of Org1, Org2 and Org3 agree.

### <Flow Example: Copy Process>

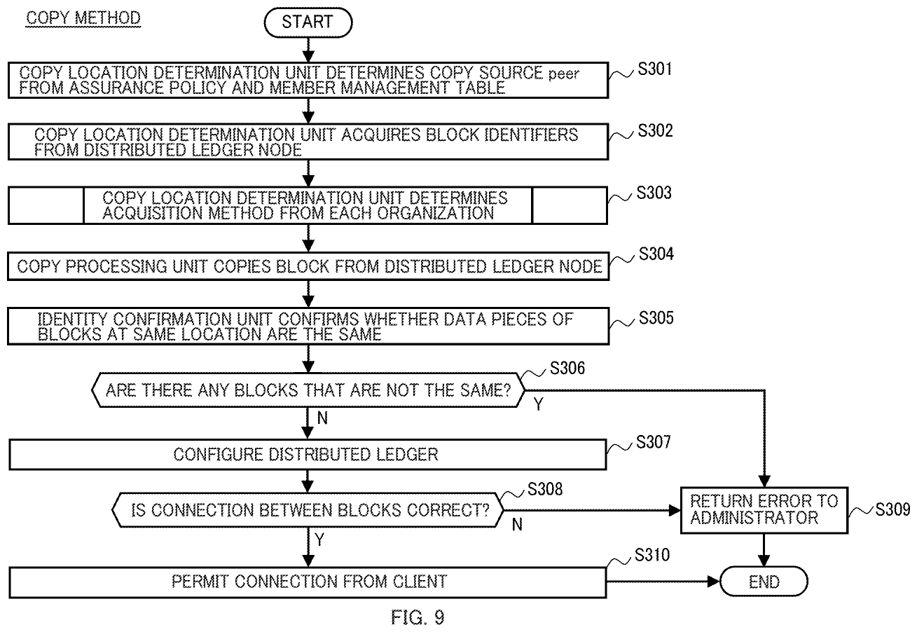

Subsequently, a process will be described which is of copying, when a new distributed ledger node 3 is added, the distributed ledger 372 from a plurality of existing distributed ledger nodes 3 to the new distributed ledger node 3. FIG. 9 is a flowchart illustrating an example of a process of copying a distributed ledger.

In this case, for example, the copy location determination unit 50 in the new distributed ledger node 3 determines a distributed ledger node 3 to be a copy source based on the assurance policy 54 and the participating member management information 38 (S301).

Taking the example illustrated in FIG. 1, copies of the blockchains 372 are made from the distributed ledger nodes 3 operated by the respective organizations org1, org2, and org3 based on the assurance policy 54. Here, the copies are made from peer1, which is the distributed ledger node 3 of org1, and peer21 and peer22, which are distributed ledger nodes 3 of org2, and peer3, which is the distributed ledger node 3 of org3.

When one organization has a plurality of distributed ledger nodes 3, one or all copies are made from one or all of the distributed ledger nodes 3. For example, a copy of the blockchain 372 may be made from the distributed ledger node 3 having the smallest CPU load, I/O load, or network bandwidth usage, a copy of the blockchain 372 may be made from the distributed ledger node 3 in which one or some of the CPU load, I/O load, and network bandwidth usage are equal to or less than a specific threshold, or copies of the blockchains 372 may be made from all the distributed ledger nodes 3 in which the blockchains 372 are distributed.

Note that the assurance policy 54 used for consensus building in FIG. 8 and the assurance policy 54 used for determining the copy source distributed ledger node 3 in FIG. 9 may be the same or different.

Next, the copy location determination unit 50 acquires an identifier for identifying each block from the distributed ledger node 3 determined in step S301 (S302). Examples of the identifier include a time stamp of each block, the hash of a previous block, the hash of a state, a hash of the block, and a combination thereof.

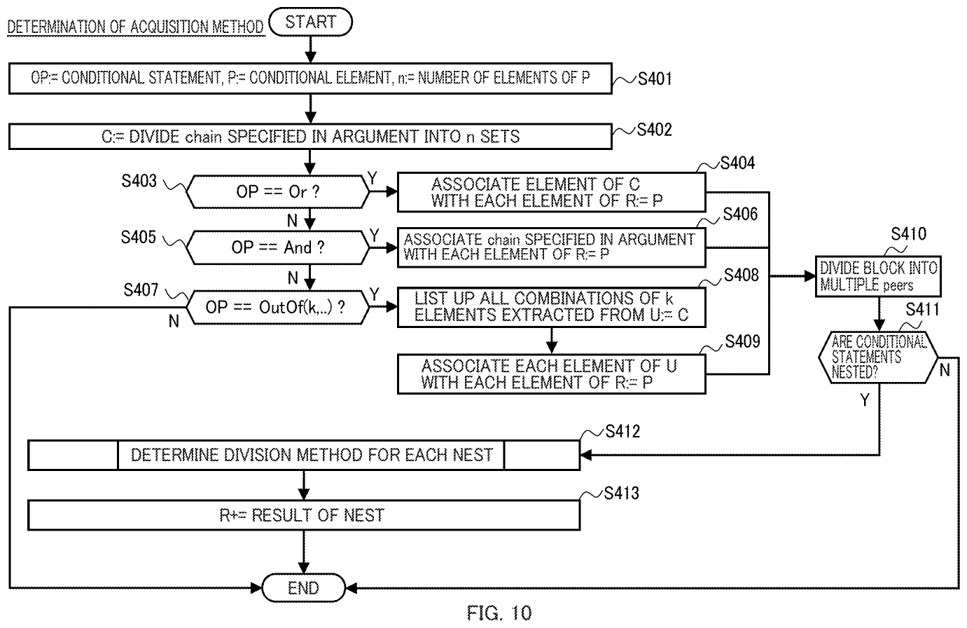

Next, the copy location determination unit 50 determines which location in the blockchain 372 is acquired from which organization 400 (S303). This process will be described in detail with reference to FIG. 10. In this process, the identifier of the block and the assurance policy 54 are passed as arguments.

Next, the copy processing unit 51 acquires a block from the distributed ledger node 3 determined in S301 in accordance with the acquisition policy determined in step S303, and copies the block to the copy buffer 53 (S304).

After the above-described copying, the identity confirmation unit 52 confirms whether the data of a plurality of blocks having the same identifier, acquired from the distributed ledger nodes 3 in different organizations is the same (S305). If there is at most one block with a certain identifier, no comparison is made.

Note that the process of step S305 may be performed after the copying of all the blocks is completed, or the identity of blocks may be confirmed when pieces of information of the same blocks are acquired from all the distributed ledger nodes 3.

As a result of step S305, if there is a block having the same content (S306: Y), the identity confirmation unit 52 determines that the data in the distributed ledger node 3 of the copy source may be tampered with, returns an error to (the client node 4 or the like of) the administrator that has invoked the process illustrated in FIG. 9 (S309), and ends the processing.

However, for blocks having a certain identifier, a block corresponding to the largest number of blocks having the same content may be determined as having a correct block value, and the processing may proceed to S307 to continue.

On the other hand, as a result of step S305, if the contents of the blocks having the same identifier are all the same (S306: N), for example, the copy processing unit 51 configures the distributed ledger 372 from the blocks in the copy buffer 53 (S307).

Then, as a result of configuring the distributed ledger 372 in step S307, the copy processing unit 51 verifies whether the connection relationship between the blocks is correct based on the hash of the previous block and the time stamp (S308).

As a result of the verification, when the connection relationship is correct (S308: Y), the processing proceeds to S310 in the copy processing unit 51. On the other hand, if there is a defect in the connection relationship (S308: N), the copy processing unit 51 determines that an error occurs, and the processing proceeds to S309 (S309).

Finally, for example, the copy processing unit 51 permits access from the client node 4 to the newly added distributed ledger 3 (S310).

### <Flow Example: Determination of Acquisition Method>

Subsequently, a process will be described which is of determining, when copying the distributed ledger 372, which part of the distributed ledger 372 serving as a copy source is to be acquired from the existing distributed processing node 3 in which organization 400. FIG. 10 is a flowchart illustrating an example of a process of determining an acquisition method.

In this case, the copy location determination unit 50 acquires the assurance policy 54 from the arguments involved when the process in FIG. 10 is invoked, and stores the conditional statement in a variable OP and the conditional elements in variables P. In addition, the copy location determination unit 50 stored the number of conditional elements P is stored in a variable n (S401).

Next, the copy location determination unit 50 divides the identifiers of the blocks of the blockchain, which are passed to the above-described arguments, into n segments, and stores the resulting segments in a variable C.

This division may be performed by any division method. In the present example, a method of segmenting so that each segment has elements of (the total number of blocks)/n while maintaining the order of the blocks connected in the blockchain will be described by way of example.

Note that the number of elements in each segment may not be equal. If a remainder is obtained by the division, the number of elements in one of the segments may be incremented by 1. Instead of the number of blocks, the division may be performed based on the total size of the blocks so that the sizes of the resulting segments are almost equal. The division may be performed so that each element of the variable C includes more blocks signed by different organizations. The division may be performed so that each element of the variable C includes blocks signed by as few organizations as possible.

Next, the copy location determination unit 50 determines the conditional statement mentioned above. If the conditional statement OP is Or (S403: Y), the copy location determination unit 50 associates each element of P with an element of C, and stores them in a variable R (S404).

Any method of associating the elements may be used. For example, the association may be made at random, or an association method may be determined based on the number and total performance of the distributed ledger nodes 3 in each organization, the maximum performance, the performance statistics information so far, the margin of the network bandwidth for connection to the distributed ledger node 3 of each organization 400, the number of elements of the block segment, the size of the block segment, and the like.

On the other hand, if the conditional statement OP is And (S405: Y), the copy location determination unit 50 associates all elements of the blockchain specified as the arguments with each element of P, and stores them in the variable R (S406).

Note that if the number of elements of P is large, for example, 10 or more, the number of P may be reduced based on some condition. For example, the reduction may be made at random, or an organization to be reduced may be determined based on the number and total performance of the distributed ledger nodes 3 in each organization, the maximum performance, the performance statistics information so far, the margin of the network bandwidth for connection to the distributed ledger node 3 of each organization 400, the number of elements of the block segment, the size of the block segment, and the like.

On the other hand, if the conditional statement OP is OutOf (k, . . . ) (S407: Y), the copy location determination unit 50 lists up all combinations of k elements extracted from the variable C, and stores them in the variable U (S408).

For example, for OutOf (2, A, B, C), combinations of two elements out of three elements of (A, B, C) are listed, which result in three combinations: (A, B), (B, C), and (A, C).

Next, the copy location determination unit 50 associates each element of U with an element of C, and stores them in the variable R (S404). Any method of associating the elements may be used. For example, the association may be made at random, or an association method may be determined based on the number and total performance of the distributed ledger nodes 3 in each organization, the maximum performance, the performance statistics information so far, the margin of the network bandwidth for connection to the distributed ledger node 3 of each organization 400, the number of elements of the block segment, the size of the block segment, and the like.

If the result of the above determination is that none of the conditional statements are met (S407: N), the copy location determination unit 50 ends the processing.

On the other hand, if any of the conditional statements is met (S403: Y, S405: Y, S407: Y), the copy location determination unit 50 further divides the blocks depending on the number of distributed ledger nodes 3 in the organizations 400 by referring to the participating member management information 38, associates the name of each distributed ledger node 3 with the corresponding block segment, and stores them in the variable R (S410).

If the elements included in the variable R do not include a conditional statement (S411: N), the copy location determination unit 50 ends the processing.

On the other hand, if the elements included in the variable R include a conditional statement (S411: Y), the copy location determination unit 50 recursively invokes the processing illustrated in FIG. 10 to analyze the conditional statement (S412), adds the result to the variable R (S413), and ends the processing.

### <Division Form of Distributed Ledger>

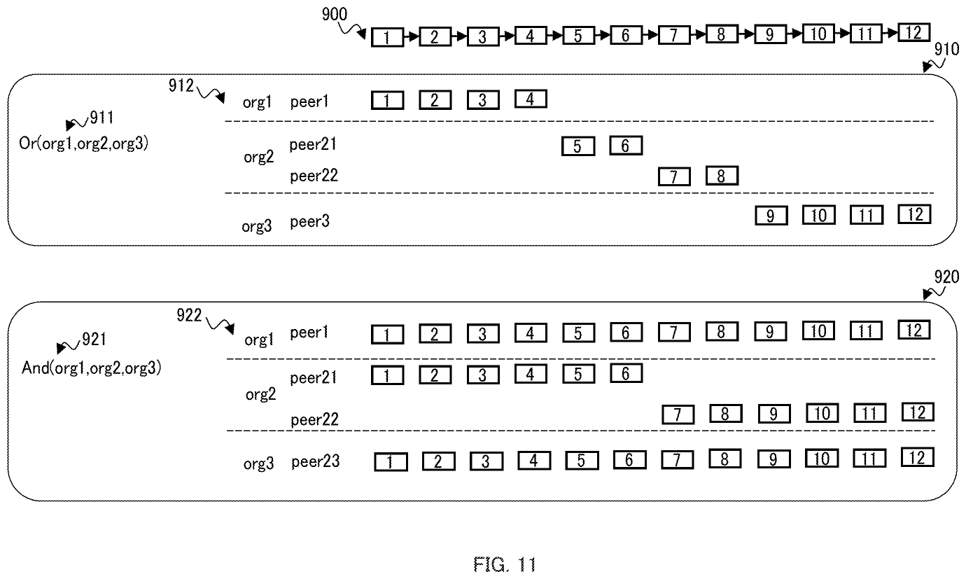

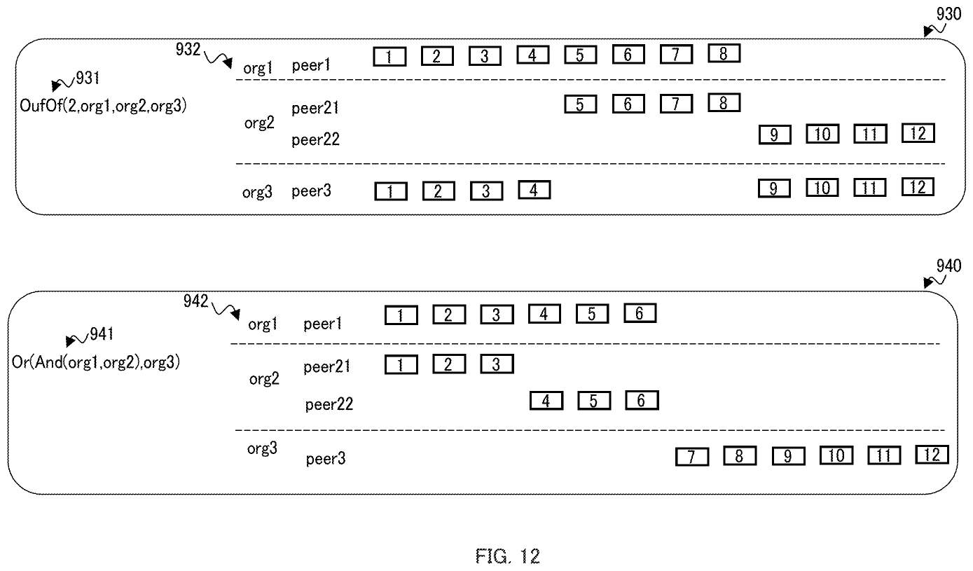

Next, a description will be given of a specific example of how the distributed ledger 372 is divided and from which node the data at a certain division location is to be acquired by the process of determining an acquisition method illustrated in FIG. 10. FIGS. 11 and 12 illustrate a specific example of a method of dividing a distributed ledger.

In FIG. 11, division forms 910, 920, 930, and 940 are examples in which the distributed ledger node 372 composed of twelve blocks 900 is divided based on the participation member management information 38 illustrated in FIG. 6 and the assurance policy 54.

Also in such division forms, blocks 912, 922, 932, and 942 are the results of dividing for each distributed ledger node 372 of the organizations based on the assurance policies 911, 921, 931, and 941.

In the division form 910, since the conditional statement is Or, an equal number of blocks are acquired from each organization. Since the organization Org2 has two distributed ledger nodes 3, they are acquired separately as peer21 and peer22.

In the division form 920, since the conditional statement is And, the same number of blocks are acquired from each organization. Since the organization Org2 has two distributed ledger nodes 3, they are acquired separately as peer21 and peer22.

In the division form 930, since the conditional statement is OutOf (2), the entire blocks are divided into three segments, and two of the segments are acquired from each organization. Since the organization Org2 has two distributed ledger nodes 3, they are acquired separately as peer21 and peer22.

Note that since the condition of OutOf can be converted into a combination of And and Or, the content of the assurance policy 54 may be converted into a combination of And and Or. For example, the content of the division form 930 is equivalent to Or(And(org1, org2), And(org2, org3), And(org1, org3)).

In the division form 940, since the condition is of mixing Or and And, the blocks are divided into two segments, and the first half is acquired redundantly from the organizations org1 and org2, and the second half is acquired from the organization org3. Since the organization Org2 has two distributed ledger nodes 3, they are acquired separately as peer21 and peer22.

By the above processing, the process of adding a new distributed ledger node 3 is accelerated, and the time until the new distributed ledger node 3 becomes usable can be reduced.

### Second Example

In the second example, an embodiment will be described in which a newly added distributed ledger node 3 is made available before the copy process according to the first example on the newly added distributed ledger node 3 ends. The basic processing is the same as in the first example.

The process of permitting the client node 4 to access the newly added distributed ledger 3 in step S310 in the flow of FIG. 9 is executed prior to step S201 in the flow of FIG. 8.

Accordingly, during execution of the process illustrated in FIG. 9, when a reference request to a block from the client node to the transaction management unit 34 is caused, the copy processing unit 51 acquires the corresponding block from the existing distributed ledger node 3, and copies the block to the copy buffer 53. Then, the copy processing unit 51 returns the acquired block to the client node 4 described above.

As a result, even during the process of adding a new distributed ledger node 3, data can be referenced from the client node 4 to the blockchain.

Although the above description is specific for the best mode for carrying out the present invention, the present invention is not limited to this, and various modification is possible without departing from the spirit and scope of the invention.

According to such an embodiment, in a distributed ledger system, when a new distributed ledger node is added or when a failure occurs an existing distributed ledger node, a copy of correct data can be made from a plurality of distributed ledger nodes that are not always reliable, while reducing the copy time and the load on other distributed processing nodes and networks.

That is, it is possible to make a copy of a blockchain from an existing distributed ledger node efficiently while preventing tampering.

At least the following will be made clear by the description in the present specification. That is, in the distributed ledger operation management method of the present embodiment, the first distributed ledger node may determine the possibility of tampering with the data held by the distributed ledger node in the distributed ledger system based on reliability defined by a predetermined algorithm, and may determine, based on the result of the determination, the second distributed ledger nodes serving as a copy source, and a copy location in the distributed ledger in each distributed ledger node of the second distributed ledger nodes.

According to this, it is possible to determine the data copy location based on the reliability of each organization. As a result, it is possible to make a copy of a blockchain from an existing distributed ledger node more efficiently while preventing tampering.

Further, in the distributed ledger operation management method of the present embodiment, the first distributed ledger node may determine the possibility of tampering in a manner of holding, as the predetermined algorithm for defining the reliability, a logical expression including operations of a logical AND and a logical OR using an organization name of each organization that owns each distributed ledger node; setting, when confirming that the data to be determined is created by an organization which is a correct creator, a location of the organization name in the logical expression to true; setting, when confirming that the data to be determined is created by an organization which is a wrong creator, a location of the organization name in the logical expression to false; and operating the logical expression after the above settings.

According to this, a data copy method can be efficiently determined based on an assurance policy such as an endorsement policy. As a result, it is possible to make a copy of a blockchain from an existing distributed ledger node more efficiently while preventing tampering.

Further, in the distributed ledger operation management method of the present embodiment, the first distributed ledger node may acquire, for an organization group having an organization name included in a term of the logical AND in the logical expression, the content of the distributed ledger from each distributed ledger node in the organization group, and may determine, when the contents of the distributed ledgers are the same, that there is no possibility of tampering.

According to this, it is possible to more efficiently check the possibility of tampering. As a result, it is possible to make a copy of a blockchain from an existing distributed ledger node more efficiently while preventing tampering.

Further, in the distributed ledger operation management method of the present embodiment, the first distributed ledger node may divide, for an organization group having an organization name included in a term of the logical OR in the logical expression, the contents of the distributed ledgers to be copied from the distributed ledger nodes in the organization group into segments, may associate the segments of the contents of the distributed ledgers with each organization group, and may acquire the associated contents of the distributed ledgers from each distributed ledger node of the group of organizations.

According to this, it is possible to acquire data that the distributed ledger node is regarded as being reliable, and thus it is possible to make a copy of a blockchain from an existing distributed ledger node more efficiently while preventing tampering.

Although the present disclosure has been described with reference to example embodiments, those skilled in the art will recognize that various changes and modifications may be made in form and detail without departing from the spirit and scope of the claimed subject matter.

What is claimed is:

1. An operation management method for a distributed ledger system,
in copying data to a distributed ledger included in a first distributed ledger node from a distributed ledger included in a second distributed ledger node group in the distributed ledger system when a content of the distributed ledger held by the first distributed ledger node is less than a content of the distributed ledger held by the second distributed ledger node group,
the operation management method comprising, by the first distributed ledger node,
determining a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

2. The operation management method for a distributed ledger system according to claim 1, further comprising, by the first distributed ledger node,
determining a possibility of tampering with data held by the distributed ledger node in the distributed ledger system based on reliability defined by a predetermined algorithm; and
determining, based on a result of the determination, the second distributed ledger node group serving as a copy source, and a copy location in the distributed ledger in each distributed ledger node included in the second distributed ledger node group.

3. The operation management method for a distributed ledger system according to claim 2, further comprising, by the first distributed ledger node,
determining the possibility of tampering in a manner of holding, as the predetermined algorithm for defining the reliability, a logical expression including operations of a logical AND and a logical OR using an organization name of each organization that owns each distributed ledger node;
setting, when confirming that the data to be determined is created by an organization which is a correct creator, a location of the organization name in the logical expression to true;
setting, when confirming that the data to be determined is created by an organization which is a wrong creator, a location of the organization name in the logical expression to false; and
operating the logical expression after the above settings.

4. The operation management method for a distributed ledger system according to claim 3, further comprising, by the first distributed ledger node,
acquiring, for an organization group having an organization name included in a term of the logical AND in the logical expression, a content of the distributed ledger from each distributed ledger node of the organization group; and
determining, when the acquired content of the distributed ledger is the same, that there is no possibility of tampering.

5. The operation management method for a distributed ledger system according to claim 3, further comprising, by the first distributed ledger node,
dividing, for an organization group having an organization name included in a term of the logical OR in the logical expression, a content of the distributed ledger to be copied from each distributed ledger node in the organization group;
associating the divided contents of the distributed ledgers with the respective organization groups; and
acquiring the associated content of the distributed ledger from each distributed ledger node of the organization group.

6. An operation management system for a distributed ledger system, comprising a first distributed ledger node in the distributed ledger system, configured to:
copy data to a distributed ledger included in the first distributed ledger node from a distributed ledger included in a second distributed ledger node group when a content of the distributed ledger held by the first distributed ledger node is less than a content of the distributed ledger held by the second distributed ledger node group; and
determine a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.

7. An operation management program for a distributed ledger system causing a first distributed ledger node in the distributed ledger system to execute a process, wherein
the first distributed ledger node is configured to copy data to a distributed ledger included in the first distributed ledger node from a distributed ledger included in a second distributed ledger node group when a content of the distributed ledger held by the first distributed ledger node is less than a content of the distributed ledger held by the second distributed ledger node group, and
the process is configured to determine a second distributed ledger node group serving as a copy source, and a copy location in a distributed ledger in each distributed ledger node included in the second distributed ledger node group in the distributed ledger system, based on predetermined criteria for a predetermined attribute related to the distributed ledger node.
